(19) United States
(12) Patent Application Publication
(10) Pub. No.: US 2003/0201395 A1
(43) Pub. Date: Oct. 30, 2003

(54) Thermal radiation detection device with a limited number of anchor points

(76) Inventors: Jean-Jacques Yon, Sassenage (FR); Andre Perez, Cordeac (FR)

Correspondence Address: Robert E. Krebs, THELEN REID & PRIEST LLP, P.O. Box 640640, San Jose, CA, 95164-0640, US

(21) Appl. No.: 10/420,325

(22) Filed: Apr. 21, 2003

(30) Foreign Application Priority Data
Apr. 29, 2002 (FR) 02 05367

(51) Int. Cl. G01J 5/00

(52) U.S. Cl. 250/338.1

(57) ABSTRACT

This invention relates to a thermal radiation detection device comprising at least two detectors each comprising an absorbent radiation membrane, held in place by at least two suspension devices (S11, S12, S21, S22) connected to a mechanical anchor point and an electrical anchor point respectively, in which at least one anchor point that is common to two adjacent detectors, is a purely mechanical anchor point for one detector and is at least an electric anchor point for the adjacent detector.

### DESCRIPTION

1. Technical Field

This invention relates to a thermal radiation detection device with a limited number of anchor points. It is particularly applicable to the field of infrared detection detectors, and more precisely to thermal effect detectors that have the advantage that they can operate at ambient temperature.

2. State of Prior Art

FIG. 1 shows a simplified view of an electromagnetic radiation detector according to known art based on the principle of thermal detection. Diagrammatically, this type of detector comprises a thin membrane absorbent to incident electromagnetic radiation suspended above a support substrate 13. This membrane 10 is fixed to the substrate 13 by means of anchor points 11. Under the effect of radiation, this membrane 10 heats up and transmits its temperature to a usually thin layer 14 deposited on it and that acts as a thermometer. Different thermometer types can be envisaged, particularly a thermistor.

The substrate 13 may be composed of an electronic circuit integrated on a silicon wafer comprising firstly thermometer stimulus and readout devices, and secondly multiplexing components to put signals output from different thermometers in series and to transmit them to a small number of outputs that can be used by a usual imagery system.

The sensitivity of this type of thermal detector can be improved by placing a thermal insulation device 12 between the absorbent membrane 10 and the substrate 13 in order to limit heat losses from this membrane 10 and consequently to protect it from overheating.

The highest performance thermal insulation devices usually used have a characteristic shape factor in which the length is maximized while the cross section (the product of width by the thickness) is minimized. These devices 12 may be oblong. Apart from their thermal insulation role, this type of oblong devices 12 also suspends the membrane 10 and holds it in place mechanically above the substrate 13.

Some of these elements may also support an electricity conducting layer that connects thermometer electrodes to the inputs of a processing circuit located either on the substrate 13 in the case of integrated readout, or on a peripheral electronic card.

These elements 12, called “suspension devices” in the remainder of this description, can perform three functions: thermal insulation, suspension of the membrane 10 and finally electrical interconnection.

A simplified analysis of the temperature rise ΔT in the absorbent membrane 10 under the effect of the power of the incident wave Pᵢ may be made in advance, without making any particular assumptions about the nature and characteristics of the thermometer. This temperature rise is given by the formula

$$Δ T = ϵ \cdot \frac{{P}_{i}}{{G}_{TH}}$$

where ε represents the fraction of the incident wave actually absorbed by the membrane 10, and G_{TH} represents the thermal conductance of the suspension devices 12. The expression of G_{TH} is given by the equation

$$\frac{1}{{G}_{TH}} = \frac{1}{{σ}_{th}} \cdot \frac{L}{W . ep} ,$$

where σₜₕ represents the thermal conductivity of the materials from which the suspension devices 12 are made, and L, W and ep represent the length, width and thickness respectively of these devices.

These data make it clear that to improve the sensitivity of these detectors for a given incident power, the temperature rise ΔT of the absorbent membrane 10 needs to be maximized, and this can be done by reducing the thermal conductance, in other words by maximizing L and minimizing the product W.ep, in other words the cross section of the suspension devices 12.

Recent technical progress in silicon microelectronics has given a new lease of life to this detectors technology.

Techniques are being made in silicon microelectronics for making thin layers and methods of miniaturizing structures by photolithography that can be used to produce suspension devices satisfying the optimization criteria defined above so that high performance detectors become possible.

Furthermore, silicon microelectronics is based on collective processes made on the silicon wafer, that can also be useful for thermal detectors. This type of process can be used to make highly complex detector matrices; typically, 320×240 detector matrices representative of the state of the art. They can also be used to make a large number of matrices collectively on a silicon wafer and therefore to reduce the individual manufacturing cost of such components. This property, together with the fact that temperature detectors can operate at ambient temperature without the need for any cooling system makes this technology particularly suitable for making low cost infrared imagery systems. However, the requirements of consumer markets such as automobile markets, make it necessary to extend this approach to reduce costs.

For this reason, reducing the size of each of these detectors provides an excellent improvement. It enables potential cost reduction factors to the extent that the dimensions of each detector have direct consequences on the size and therefore the cost of the camera, the optics (particularly expensive in the infrared range), and the detection chip and its packaging.

However, a reduction in the size of these detectors causes a number of unwanted technical consequences. There is no doubt that the most serious of these consequences is degradation of the electro-optical performances. One known solution for limiting this reduction in performances is to reduce the cross section of detector suspension devices 12. This type of solution is one way of improving their thermal insulation and consequently their sensitivity. The use of appropriate photolithographic processes and the development of processes for the deposition of very thin layers is one means of obtaining such a result.

But this exercise to reduce the cross section of suspension devices is limited by the mechanical strength of the suspended membranes that will tend to reduce as the said cross section is reduced.

The structure as illustrated in FIG. 1 and as described in document reference [1] at the end of this description, that includes an absorbent membrane 10 held in place by two oblong suspension devices 12 attached to two anchor points 11 that also provide the electrical interconnection between the membrane and the subjacent substrate, is badly adapted to such an operation to reduce the cross section of the suspension devices. This operation causes a deflection of these devices 12, which can cause swinging of the absorbent membrane 10 until it comes into contact with the substrate 13, thus short circuiting the thermal insulation of the suspension devices 12.

One first solution for overcoming these difficulties is described in document reference [2]. According to this solution, that is shown in FIG. 2, tipping of the suspended membranes is prevented by the addition of a mechanical connection 15 that connects two adjacent membranes 10 to each other. The disadvantage of this solution lies in thermal coupling introduced by the mechanical connection between these two adjacent detectors, that will cause a degradation in the spatial resolution of the component.

A second solution, described in document reference [3], consists of arranging additional support elements 16 located at the corners of the detector opposite the usual anchor points 11. FIG. 3 shows three detectors in a matrix according to this structure characterized by:

two anchor points 11 that perform mechanical support and electrical connection functions for each detector,

two additional support elements 16 that only perform a mechanical role and that can advantageously be common to four adjacent detectors and that can be considered like anchor points.

By construction, the anchor points 11 and the additional support elements 16 are located on the output side of the suspension devices 12. Therefore, they are isothermal with the substrate 13. Furthermore, they are usually non-absorbent for the radiation. From the point of view of the detection capacity, these elements may be considered like disturbing elements that should therefore be minimized. Therefore, this second solution has the disadvantage that it contains a large number of these elements 11 and 16: therefore the ratio of the number of these elements to the number of detectors that share them is 2.5 anchor points per detector.

The number of this type of anchor points can be reduced using the concept described in document reference [4]. This document describes a particular means of addressing and multiplexing detectors in which interconnection means common to two adjacent detectors can be used, for example located on the same row. A combination of this type of concept with additional support elements, like those presented in document reference [3], is a means of reaching a solution with a higher optical performance and that has good mechanical stability properties. This solution is shown in FIG. 4, that shows part of the matrix composed of 3×3 detectors. Each detector is composed of an absorbent membrane 10 held in place by four suspension devices 12, each connected to a particular anchor point 11. Two of these four anchor points 11 are qualified as “electrical anchor points” 11, and form electrical interconnections for the detector in addition to their mechanical support function. The two other anchor points are qualified as “mechanical anchor points” 16, and perform a purely mechanical function. The structure of FIG. 4 is characterized by 1.5 anchor points per detector. The performance of this solution is better than the previous solution, but it still has a number of disadvantages:

it includes a residual number of purely mechanical anchor points that perform no functional detection purpose. The filling factor, in other words the fraction of the detector surface that actually participates in detection, is correspondingly reduced;

it is characterized by a particular topography which means that electrical anchor points need to be put together in pairs. This proximity complicates technological photolithography and etching processes, which define the said anchor points. This disadvantage must be corrected either by relaxed pattern rules that will limit the performances of the detector, or by technological equipment with better resolution and therefore that is more expensive. This disadvantage is particularly critical when the size and pitch of the detectors are small.

The purpose of the invention is to propose a structure of thermal radiation detectors capable of overcoming the mechanical deformations usually accompanied by a reduction in the cross section of suspension and thermal insulation devices for suspended membranes, while maintaining an excellent detection capacity.

Presentation of the Invention

The invention relates to a thermal radiation detection device comprising at least two detectors each comprising an absorbent radiation membrane, held in place by at least two suspension devices connected to a mechanical anchor point and an electrical anchor point respectively, characterized in that at least one anchor point, which is an anchor point common to two adjacent detectors, is a purely mechanical anchor point for one detector and is at least an electric anchor point for the adjacent detector.

In one advantageous embodiment, each anchor point is shared between four detectors. At least one central detector, in other words a detector that is surrounded by adjacent detectors on all sides, is connected to four anchor points through four suspension devices respectively. Each of these four anchor points, which are common to the four adjacent detectors, comprises the mechanical support and electrical interconnection functions. Two first anchor points provide electrical connections for the central detector and part of the electrical connections for the two adjacent detectors located on the same line, while two other anchor points form part of the electrical connections of the two adjacent detectors located in the same column on the upper line and lower line respectively.

The invention can achieve the following advantageous results:

the fact that there are four anchor points per detector provides better mechanical stability that enables the manufacture of small cross section suspension and thermal insulation devices, which is good in terms of thermal sensitivity and therefore performance;

the fact that anchor points common to four adjacent detectors are available means that the detector filling factor and therefore its performance can be maximized;

the fact that all anchor points combine mechanical support and electrical connection functions eliminates the need for anchor points specifically arranged for mechanical purposes, which reduces the detection quality; in other words, all anchor points according to the invention perform a functional role from the point of view of the electro-optic detection function;

the topography of this arrangement makes it possible to broadly separate the different anchor points from each other. This property simplifies technological photolithography and etching processes that define the said anchor points. This results in rules for defining patterns in which the separation distance between these elements does not need to be reduced in proportion to the size of the detector; as a result it becomes easier to make detectors at a smaller spacing according to this configuration, using technologically less sophisticated means and therefore less expensive technological means than would be necessary to make structures according to prior art.

### BRIEF DESCRIPTION OF THE DRAWINGS

FIGS. 1 to 4 illustrate different detection devices according to known art.

FIG. 5 illustrates the thermal detection device according to the invention.

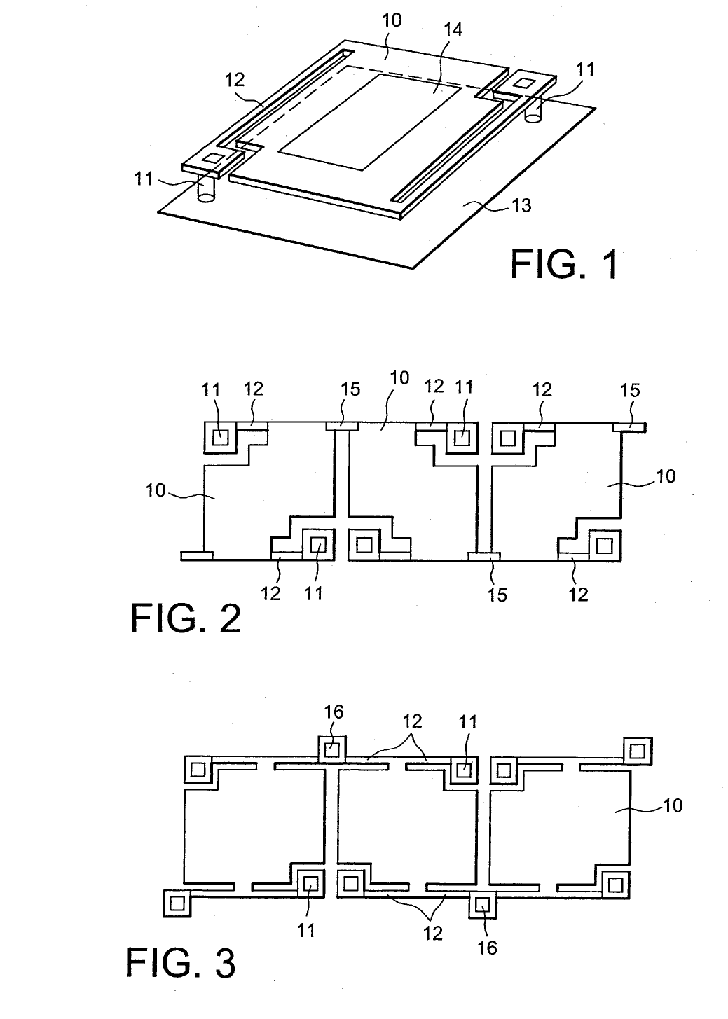

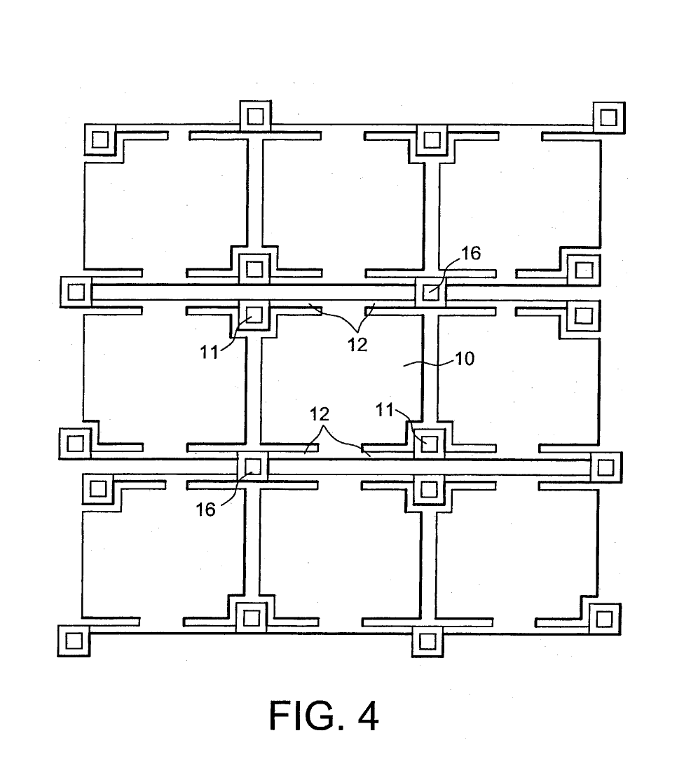

### DETAILED PRESENTATION OF EMBODIMENTS

The thermal radiation detection device according to the invention comprises anchor points common to several detectors, performing different functions for two adjacent detectors, unlike solutions according to prior art described above; in other words, a purely mechanical support function for a first detector, and at least one electrical connection function for a second detector.

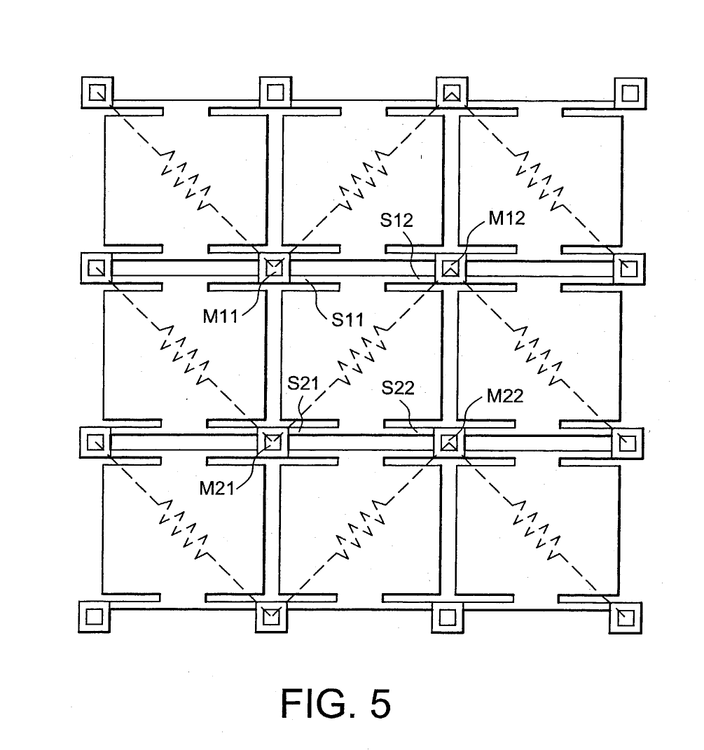

Part of the 3×3 matrix of thermal radiation detectors thus made is illustrated in FIG. 5.

Each detector is composed of an absorbent membrane held in place by at least two suspension devices connected to at least two anchor points each fulfilling two functions, firstly a mechanical support function for the suspended membrane, and secondly an electrical interconnection function to measure the detector signal. Furthermore, this membrane is held in place by two other anchor points that perform a mechanical maintenance function for the membrane alone and a function for mechanical maintenance and electrical interconnection for detectors adjacent to this detector.

The current flux passing through each detector is shown diagrammatically by the electrical symbol for a resistance that also specifies the electrical connection points of each of these detectors.

As shown in this FIG. 5, the central detector, in other words a detector surrounded by adjacent detectors in all directions, is connected to four anchor points denoted M11, M12, M21 and M22 through four suspension devices S11, S12, S21 and S22 respectively. Each of these four anchor points common to four adjacent detectors, combines the mechanical support and electrical interconnection functions. Anchor points M12 and M21 provide electrical connections for the central detector and some of the connections for the two adjacent detectors located on the same line, while the anchor points M11 and M12 provide some of the electrical connections for the two adjacent detectors located in the same column on the upper line and on the lower line respectively, and perform a mechanical maintenance function only for the central detector. Obviously, the role of the rows and columns could be inverted without going outside the scope of the invention.

According to the proposed architecture, the number of anchor points as a fraction of the number of detectors that share them is one anchor point for a detector, which is a saving of 0.5 relative to prior art.

### REFERENCES

[1] FR 96 10005

[2] FR-A-2 788 885

[3] “Amorphous silicon based uncoated microbolometer IRFPA” by Corinne Vedel (Apr. 5-9, 1999, Orlando, USA, SPIE Conference, Volume 3698)

[4] FR-A-2 802 338

1. Thermal radiation detection device comprising at least two detectors each comprising an absorbent radiation membrane, held in place by at least two suspension devices (S11, S12, S21, S22) connected to a mechanical anchor point and an electrical anchor point respectively, characterized in that at least one anchor point, which is an anchor point common to two adjacent detectors, is a purely mechanical anchor point for one detector and is at least an electric anchor point for the adjacent detector.

2. Device according to claim 1, in which each anchor point is shared between four detectors.

3. Device according to claim 2, comprising at least one central detector connected to four anchor points (M11, M12, M21, M22) through four suspension devices (S11, S12, S21, S22) respectively, each of these four anchor points comprising the mechanical support and electrical interconnection functions.

4. Device according to claim 3, in which two first anchor points (M12, M21) provide electrical connections for the said central detector and part of the electrical connections for the two adjacent detectors located on the same line.

5. Device according to claim 4, in which two other anchor points (M11, M22) form part of the electrical connections of two adjacent detectors located in the same column on the upper line and lower line respectively.
